(19) United States
(12) Patent Application Publication
(10) Pub. No.: US 2025/0337810 A1
(43) Pub. Date: Oct. 30, 2025

(54) AUTOMATED METER READING THROUGH A FIXED-WIRE TELECOMMUNICATIONS NETWORK

(71) Applicant: Centric Fiber HoldCo, LLC, The Woodlands, TX (US)

(72) Inventors: Jason Palmenberg, The Woodlands, TX (US); Yuxin Dai, Santa Rosa, CA (US)

(21) Appl. No.: 19/182,273

(22) Filed: Apr. 17, 2025

Related U.S. Application Data
(63) Continuation-in-part of application No. 18/498,327, filed on Oct. 31, 2023.

(51) Int. Cl. H04L 67/12; H04L 12/66

(52) U.S. Cl. CPC H04L 67/12; H04L 12/66

(57) ABSTRACT

An IoT (Internet of Things) gateway includes a data framing module including an input for receiving serial data from a utility meter and an output for sending application layer protocol frames to a network gateway, wherein the data framing module is configured to include the serial data in the application layer protocol frames selected from hyper-text transfer protocol frames, WebSocket protocol frames, TCP frames, and UDP frames. The IoT gateway may include a radio frequency receiver for receiving utility meter usage data transmitted by a utility meter according to one or more existing IoT protocols such as SCM/SCM+, LoRa, NB-IoT. In some options, a network gateway may be integrated with the IoT gateway to provide a single device. The IoT gateway and network gateway may be implemented in a system including the utility meter, a wide area network and an application server or data storage system.

### CROSS REFERENCE TO RELATED APPLICATIONS

This application is a continuation-in-part of U.S. patent application Ser. No. 18/498,327, filed Oct. 31, 2023, which is incorporated herein by reference in its entirety as if fully set forth below in its entirety and for all applicable purposes.

### BACKGROUND

The present disclosure relates to the Internet of Things (“IoT”), automated utility meter reading and telecommunication networks.

### Background of the Related Art

Utilities such as electrical power, natural gas and water are typically distributed from large, centralized sources to individual utility consumers over a wide area. A utility meter is located at the point of consumption for each utility consumer, such as an individual residence or business. A utility system will include many such utility meters that operate independently of each other utility meter. To monitor the amount of a utility consumed by each utility consumer, each utility meter must output utility meter data and the utility system must collect the utility meter data output by each utility meter.

For example, one widely used utility meter reading method/system defined as “legacy system” here, may employ a semi-automated system. The legacy system includes individual utility meters that generate meter data, including meter ID, date, time and amounts of utility consumption. The utility meter packs the meter data into data frames, then transmits the data frames via radio frequencies, for example, ranging from 908 MHz to 928 MHz. A mobile hand-held or vehicle-based meter data collection device must be physically moved around the utility system so that the data collection device is briefly located within the signal range of each utility meter's transmitter. When the mobile data collection device is within range of an individual utility meter, the meter data from that individual utility meter is automatically recorded by the mobile data collection device. If meter data from a particular utility meter is missing from the collected data set, the mobile collection device must make another trip to the location of that particular utility meter. Because significant effort is necessary to collect meter data from every utility meter, meter data is typically collected no more than once a month.

Other utility meter reading methods/systems use an automated system using a private network based on LoRa. LoRa (which gets its name from the term “long range” radio) is a low power consumption local private area network that is used to collect meter data from LoRa utility meters. A LoRa utility meter will transmit radio frequency signals over a distance of up to 2-5 kilometers to a LoRa gateway. The LoRa gateways retransmit the meter data over a private LPWAN (Low Power Wide Area Network) to a server.

Yet another method/system for reading utility meters is known as NB-IoT (Narrow Band Internet of Things). It uses public 4G wireless networks to transport utility meter data. Accordingly, the NB-IoT network consists of NB-IoT terminals (utility meters), NB-IoT base stations that communicate with each of the individual NB-IoT terminals via 4G wireless links, a 4G core network and NB-IoT servers in the cloud that collect the meter data.

### BRIEF SUMMARY

Some embodiments provide an IoT (Internet of Things) gateway comprising a data framing module including an input for receiving, via a serial data interface, the meter data frames from a utility meter through a radio link and an output for sending application layer protocol frames to a network gateway, wherein the data framing module is configured to embed the meter data frames in the application layer protocol frames, for example hyper-text transfer protocol frames, WebSocket protocol frames, or MQ Telemetry Transport (MQTT) frames, etc.

Some embodiments provide a system comprising a utility meter including a sensor for measuring utility usage and a transmitter for transmitting utility usage data. The system further comprises an IoT gateway including a data framing module for receiving the utility usage data and outputting an application layer protocol frame containing the utility usage data and a destination address for an application server or data storage system, wherein the application layer protocol frame such as a hyper-text transfer protocol frame, a WebSocket protocol frame, or an MQTT frame is decoded. Still further, the system comprises a network gateway in communication with the IoT gateway for receiving the application layer protocol frame from the IoT gateway and forwarding the application layer protocol frame to the application server or data storage system over a wide area network.

Some embodiments provide a method of handling utility usage data. The method comprises receiving a radio frequency signal from a utility meter, wherein the radio frequency signal includes a utility meter data frame including an amount of utility usage measured by the utility meter, and demodulating the radio frequency signal to obtain the utility meter data frame. The method may further comprise mapping the utility meter data frame into an Internet Protocol packet, mapping the Internet Protocol packet into an application layer protocol frame, for example, a Hypertext Transfer Protocol (HTTP) frame, a WebSocket frame, or an MQTT frame, etc., and sending the application layer protocol frame to a network gateway for forwarding to an application server or data storage system over a wide area network.

Some embodiments provide a method of detecting a leaking utility. The method comprises a residential network gateway receiving a utility usage amount from a utility meter, the residential network gateway forwarding the utility usage amount over a public fixed wire network using technologies such as a Passive Optical Network (PON), Hybrid Fiber-Coaxial (HFC) network, or any digital subscriber line (XDSL) technology for data transportation, to a processing computer located at a data collection point, and the processing computer determining whether the utility usage amount is greater than a standard deviation threshold above utility usage amounts received from the utility meter during one or more historical periods and/or utility usage amounts received from one or more other utility meters during a current period. The method may further comprise the processing computer generating a service notification in response to determining that the utility usage amount is greater than a standard deviation threshold above the utility usage amounts received from the utility meter during one or more historical periods and/or the utility usage amounts received from the one or more other utility meters during a current period.

### BRIEF DESCRIPTION OF THE SEVERAL VIEWS OF THE DRAWINGS

FIG. 1 is a diagram of a system that supports automated utility meter reading and communication over a telecommunications network.

FIG. 2 is a diagram of a system with the broadband network implemented as a passive optical fiber network (PON) for example purposes.

FIG. 3 is a diagram a system including an integrated broadband home network gateway/IoT gateway.

FIG. 4 is a diagram of the components of an integrated network gate/IoT gateway for sending an HTTP frame to a wide area network.

FIG. 5 is a diagram of an integrated network gateway/IoT gateway that forms a WebSocket connection for sending utility usage data.

FIG. 6 is a diagram of an IoT gateway connected to an external broadband home network gateway for sending an HTTP frame to a wide area network.

FIG. 7 is a diagram of an IoT gateway connected to an external broadband home network gateway using a WebSocket connection.

FIG. 8 is a diagram of an IoT gateway connected to an external broadband home network gateway for sending an MQTT frame to servers via a wide area network.

FIG. 9 is an illustration of the OSI layers and typical protocols for each layer.

FIG. 10A is an exemplary MQTT packet.

FIG. 10B is an exemplary HTTP packet.

FIG. 11A is an exemplary mapping from an SCM packet to JSON in an MQTT packet.

FIG. 11B is an exemplary mapping from an R900 packet to JSON in an HTTP packet.

FIG. 12A is a flowchart of operation of the Wi-Fi SoC of FIG. 8.

FIG. 12B is a flowchart of operation of the Sub-GHz Radio SoC of FIG. 8.

FIG. 13 is a flowchart of operations to initialize the IoT gateway.

FIG. 14 is a diagram of an integrated broadband/IoT gateway.

### DETAILED DESCRIPTION

Some embodiments provide an IoT (Internet of Things) gateway comprising a data framing module including an input for receiving data frames from a utility meter via a serial port and an output for sending application layer protocol frames to a network gateway, wherein the data framing module is configured to embed the meter data frames in the application layer protocol frames such as hyper-text transfer protocol (HTTP) frames, WebSocket protocol frames, or MQ Telemetry Transport (MQTT) protocol frames.

The Internet of Things (IoT) describes devices with sensors, processing ability, software/firmware and/or other technologies that connect and exchange data with other devices and systems over a wide area network (such as the Internet) or other communications networks, such as a virtual private network (VPN). An individual IoT device may have one or more sensors, a processor and software and/or firmware executable by the processor. The individual IoT device may also include additional components, such as network interfaces or signal transceivers, without limitation. Furthermore, the processor and software and/or firmware may be replaced or supplemented with an application-specific integrated circuit (ASIC), a field-programmable gate array (FPGA) or a system-on-chip (SoC).

An individual IoT device, such as a utility meter, may have any or more sensor types as required by a particular application. For example, the one or more sensor types may be selected from a proximity sensor, accelerometer, motion detector, photoelectric sensor, capacitive sensor, thermistor, temperature sensors, gyroscope, image sensor, smoke detector, hall effect sensor, thermocouple, infrared sensor, ultrasound sensor, magnetism sensor, acoustic sensor, level sensor, gas detector, pressure sensor, humidity sensors, accelerometers, and flow sensors/meters. In addition to one or more sensor, the IoT device or utility meter may have a sampling and data processing unit, a transmitter unit, and a power source or connection to a power source.

An Internet of things (IoT) gateway provides the bridge (protocol converter) between one or more IoT devices in the field, one or more other devices on a wide area network (WAN) or in a cloud, and perhaps servers and user equipment such as a smartphone. The IoT gateway provides a communication link between one or more IoT devices in the field and one or more devices in a WAN or cloud and may provide real-time control of the one or more IoT devices in the field. Optionally, the IoT gateway may provide a communication link between one or more IoT devices in the field and one or more devices in a local area network (LAN), such as a home network gateway, in addition to one or more devices in a WAN or cloud. Without limitation, the one or more devices in the WAN, cloud or LAN may be one or more computers, such as one or more servers, one or more cluster of servers, or one or more cloud.

The data framing module is configured to embed the meter data frames (serial data) into the application layer protocol frames such as hyper-text transfer protocol frames, WebSocket protocol frames, and MQTT protocol frames. Accordingly, the data framing module preferably has at least one serial port for receiving the meter data frames and at least one Ethernet port or internal bus for transmitting the application layer protocol frames. In some embodiments, the data framing module may be an application specific integrated circuit (ASIC) that is programmed to perform the operations needed to embed the serial data (meter data frames) into the application layer protocol frames. Optionally, the data framing module may convert serial data frames into HTTP/UDP (Hypertext Transfer Protocol/User Datagram Protocol) frames. The data framing module may cause a destination address to be included in the application layer protocol frames. For example, the destination address may identify an application server or a data storage system that is accessible via the wide area network.

The Hypertext Transfer Protocol (HTTP) is an application layer protocol in the Internet protocol suite model for distributed, collaborative, hypermedia information systems. WebSocket is a computer communications protocol, providing persistent full-duplex communication channels over a single Transmission Control Protocol (TCP) connection. MQTT is a lightweight, publish-subscribe messaging protocol designed for machine-to-machine communication, particularly in resource-constrained environments like IoT.

A network gateway, which may be a broadband home network gateway, is a unit of networking hardware and/or software that allows data to be communicated between one discrete network and another discrete network. For example, a residence or business may have a network gateway that separates their local area network (LAN) from a wide area network (WAN), such as the Internet or broadband access network. Furthermore, the network gateway may be combined with router and/or modem functionality in separate devices or one single device, sometimes referred to as a residential gateway.

In some embodiments, the utility meters cause their utility usage (consumption) data and a utility meter identifier, and perhaps also a data and time, to be transmitted (i.e., “bubble up”) within the specified radio frequency spectrum with a proprietary data frame called SCM/SCM+ (Standard Consumption Message/Standard Consumption Message Plus). For example, a utility meter may send a data frame using SCM/SCM+that includes some or all the following: date, time, communication protocol (SCM, SCM+, Interval Data Message (IDM), Net Meter IDM, R900 (Neptune meters), R900bcd (Neptune R900 using binary-coded digits), meter ERT ID (“Endpoint ID or ID), Consumption, Endpoint Type which is a code for the meter make type, ProtocolID which is a code for the broadcasting method being used, tamper codes, and packet CRC value. The “bubble up” communication or transmission of utility usage data can occur periodically, such as at a every 15, 30, or 60 seconds to 5 minutes depending on a utility meter communication setting used by the utility meter. This communication setting may be established and/or modified within the utility meter through an interface using the encoder receiver transmitter (ERT) protocol. The IoT gateway will then receive the radio signal or other transmission from the utility meter as often as a message “bubbles up” and is transmitted. However, interference from other nearby utility meters “bubbling up” at the same time on the same frequency or from other natural occurrences may or may not prevent a particular transmission of utility usage data to be received or accurately read by the IoT gateway. Fortunately, outside sources of interference are limited when the IoT gateway is deployed at the same location (i.e., home, business, property) as the utility meter due to the stronger signals and closer proximity of the transmitter (utility meter) and the receiver (IoT gateway).

In some scenarios an IoT gateway may receive data from multiple neighboring meters in close proximity depending on the radio receiver sensitivity. Still, multiple utility meters in the same general area could “bubble up” at the same time on the same frequency and be received by any given IoT gateway depending on the localized IoT gateway placement. Worst case scenario is the utility meters which encountered interference from being on the same frequency at the same time during the original bubble-up will eventually be read by the IoT gateway as they randomly jump frequencies across the spread spectrum and re-transmit at a randomly chosen time. Once the IoT gateway collects and passes the utility usage data to an application server, data storage system or other computer system, the application server, data storage system or other computer system may then process the utility usage data and determine how to handle the data. For example, if the received utility usage data is from a single utility meter associated with an account or entity that is being serviced by the application server, then the application server or other computer system may store the utility usage data in association with the account or entity. If the received utility usage data is from multiple utility meters associated with multiple accounts or entities being serviced by the application server, then the application server or other computer system may store the utility usage data in association with corresponding accounts or entities. Furthermore, if the application server, data storage system or other computer system receives utility usage data from one or more utility meters that are not associated with an account or entity being serviced by the application server, then the utility usage data may be discarded. It is also possible that first and second IoT gateways in close proximity (i.e., in the same neighborhood) may each receive the radio signals containing utility usage data from first and second utility meters, where the first IoT gateway and first utility meter are on a first property and where the second IoT gateway and the second utility meter are on a second property. Since each transmission of utility usage data also includes a utility meter identifier and a time stamp, the application server or other computer system will recognize the redundant utility usage data. After verifying that any given utility usage data is redundant to utility usage data already received, the redundant data may be discarded. Alternatively, the application server may instruct the first IoT gateway to discard data for the second utility meter and the second IoT gateway to discard data for the first utility meter. As an enhancement, the IoT gateways could detect RF signal strength for each utility meter and provide the RF signal strength value as part of the utility meter data. The application server can then evaluate the RF signal strength from a given utility meter from each IoT gateway and instruct all but the IoT gateway having the strongest RF signal strength to discard the data for the given utility meter.

In some embodiments, the IoT gateway may further comprise the broadband home network gateway, wherein the broadband home network gateway is connected to the output of the data framing module and includes an uplink port for communication over a wide area network. Accordingly, the device may be an integrated network gateway/IoT gateway device. Having both the network gateway and the IoT gateway in a single device may be both convenient and eliminate some cable connections, but an integrated network gateway/IoT gateway device may make efficient use of a single central processing unit (CPU) with sufficient processing power, memory resources, and capability for control of both the network gateway and the IoT gateway device, such as providing clock and synchronization, memory and buffer management, scheduling, and I/O management. In some options, the integrated network gateway/IoT gateway device may implement the network gateway and the IoT gateway on a single PCB (printed circuit board) or connected printed circuit boards within a single housing.

In some embodiments, the IoT gateway may further include, or have a port for connection with an Internet service provider's access network device, such as an optical network terminal (ONT), DSL modem, cable modem, etc., depending on the type of access network technology used by the service provider Accordingly, the access network terminal may be connected to any type of public fixed broadband access network, such as a Passive Optical Network (PON), Hybrid Fiber-Coaxial (HFC) network, or any digital subscriber line (XDSL) technology for data transportation.

In some embodiments, the network gateway providing the broadband Internet access may also provide various IPTV services and/or telephone service. For example, an integrated broadband network gateway/IoT gateway may have all the broadband home network gateway functions, such as supporting “triple-play” (typically broadband Internet access, IPTV and telephone), and may serve as a unified IoT gateway supporting various IoT protocols. In a further option, the home gateway and/or the IoT gateway may also have wireless networking (Wi-Fi) capabilities, such as Wi-Fi for connecting the IoT devices and/or computing devices on a local area network (LAN).

In some embodiments, the IoT gateway may further include a radio-frequency wireless receiver tuned to receive one or more radio-frequency signal containing the serial data from the utility meter and/or other IoT device. The radio-frequency receiver may be connected to the input of the data framing module (i.e., a serial port) and may provide the serial data from the utility meter to the data framing module. The IoT gateway may include any number of one or more receivers that support (A) RF radio, (B) LoRa, and/or (C) NB-IoT, such that any of these meter/device types can be “read” wirelessly by the IoT gateway. Because there is a large installed base of utility meters that utilize these various communications methods, the IoT gateway may be able to read any or all of these types of communications. Furthermore, the IoT gateway may include a Wi-Fi receiver and/or a wired port for communication with the utility meter or other IoT device. However, shifting the entire utility monitoring system to a new utility meter would involve a huge and potentially disruptive roll-out. Rather, embodiments of the IoT gateway are preferably compatible with the large installed base of various legacy utility meters by including the capability to handle one or more of these legacy data transfer and communication methods or protocols. Specifically, a system including the IoT gateway may be backward compatible with various types of utility meters and other IoT devices, such as large installed legacy AMR (Automated Meter Reading) utility meters in North America, such as Itron AMR. It is a technical and/or technological benefit to have an IoT gateway on site with the utility meter to capture these wireless signals and forward them over one or more fixed broadband telecommunications networks.

In some embodiments, the utility meter measures an amount of utility usage and the serial data contained in the radio-frequency signal includes the amount of utility usage. The radio frequency wireless receiver may be tuned to receive predetermined ranges of radio frequency spectrums that are used by the transmitter of the utility meter. Optionally, the radio frequency wireless receiver of the IoT gateway may be configured to receive spread spectrum radio signals. In some specific examples, the radio frequency wireless receiver may be configured to receive LoRa data frames transmitted by a LoRa utility meter, data frames transmitted by a legacy utility meter, and/or utility meter data using a wireless 4G mobile protocol (such as NB-IoT). Furthermore, the IoT gateway may include one or more radio frequency wireless receivers configured to receive a first radio-frequency signal transmitted by a LoRa utility meter, a second radio-frequency signal transmitted by a second legacy utility meter, and/or a third NB-IoT utility meter using a wireless 4G mobile protocol/Wi-Fi. The IoT gateway and/or an integrated network gateway/IoT gateway are preferably compatible with existing or future home networking devices, architecture and protocols for data collection.

In some embodiments, the IoT gateway may further comprise one or more networking ports for wired communication with at least one IoT device other than the utility meter. The wired networking ports may be Ethernet ports and such Ethernet ports may incorporate Power over Ethernet (POE) to provide electrical power to the utility meter through an Ethernet cable. In a further option, the IoT gateway may include a battery back-up providing emergency power to the IoT gateway and perhaps also to the utility meter via the Power over Ethernet.

Some embodiments provide a system comprising a utility meter including a sensor for measuring utility usage and a transmitter for transmitting utility usage data. The system further comprises an IoT gateway including a data framing module for receiving the utility usage data and outputting an application layer protocol frame containing the utility usage data and a destination address for an application server or data storage system, wherein the application layer protocol frame is selected from a hyper-text transfer protocol frame, a WebSocket protocol frame and an MQTT frame. Still further, the system comprises a network gateway in communication with the IoT gateway for receiving the application layer protocol frame from the IoT gateway and forwarding the application layer protocol frame to the application server or data storage system over a wide area network.

In some embodiments, the system may include any one or more aspects of the IoT gateway, network gateway, and/or radio frequency receiver disclosed above in reference to the IoT gateway embodiments. As a non-limiting example, the utility meter transmitter may be a radio frequency transmitter for transmitting a radio frequency signal containing the utility usage data, the IoT gateway may include a radio frequency receiver tuned to receive the radio-frequency signal from the utility meter transmitter, and the radio frequency receiver may provide the utility usage data to the IoT gateway. Furthermore, the radio frequency transmitter may be a spread spectrum transmitter and the radio frequency receiver may be a spread spectrum receiver. In one option, the utility meter may form a data frame containing the utility usage data and may transmit the data frame in the radio frequency signal, wherein the radio frequency receiver may receive the radio frequency signal and provide the utility usage data to the data framing module. In another option, the radio frequency transmitter of the utility meter may be a LoRa transmitter and the radio frequency receiver of the IoT gateway may be tuned to receive LoRa data frames transmitted by the LoRa transmitter. The data framing module may include a serial port for receiving the serial data stream from the radio-frequency receiver.

In some embodiments, the system further comprises a central processing unit, wherein the network gateway is integrated with the IoT gateway and the central processing unit provides a clock signal to the data framing module, the radio frequency receiver and the network gateway.

In some embodiments, the system may further comprise an optical network transmitter that communicates with the network gateway for sending the application layer protocol frame over a passive optical network to a collection point for forwarding to the application server or data storage system over the wide area network. The passive optical network may include a plurality of Optical Line Terminals (OLTs) wherein each OLT connects with an optical fiber that is split passively to connect with a plurality of ONTs (Optical Network Terminal), and each ONT may connect to a home network gateway. For example, each of the plurality of optical fibers may be split and connected to between 8 and 32 ONTs. In one option, the home network gateway may forward the application layer protocol frame to the application server, wherein the application server may be an Internet-of-Things server, broadband billing server and/or utility billing server.

In some embodiments of the system, the utility meter may transmit the utility usage data to the IoT gateway using an IoT protocol, for example the LoRa protocol, Narrow Band Internet of Things protocol (NB-IoT), Standard Consumption Message protocol, or Standard Consumption Message Plus protocol, etc. Optionally, the network gateway may be in communication with the IoT gateway over an Ethernet connection or a Wi-Fi connection.

Some embodiments provide a method of handling utility usage data. The method comprises receiving a radio frequency signal from a utility meter, wherein the radio frequency signal includes a utility meter data frame including an amount of utility usage measured by the utility meter and demodulating the radio frequency signal to obtain the utility meter data frame. The method may further comprise mapping the utility meter data frame into an Internet Protocol packet, mapping the Internet Protocol packet into an application layer protocol frame selected from a Hypertext Transfer Protocol frame, WebSocket frame, and an MQTT frame and sending the application layer protocol frame to a network gateway for forwarding to an application server or data storage system over a wide area network.

In some embodiments, the method of handling utility usage data may include any one or more aspects or uses of the utility meter, IoT gateway, network gateway, radio frequency receiver, data framing module, broadband network, application server and/or data storage system disclosed above in reference to the IoT gateway embodiments and/or system embodiments.

In some embodiments, the method may further comprise analyzing the amount of utility usage to identify a utility usage rate and determining whether the utility usage rate indicates that there is a leak within a utility monitored by the utility meter, degradation of flow within the utility monitored by the utility meter, and/or failure of the utility meter.

In some embodiments, the utility meter data frame may be encrypted by the utility meter or the data framing module, and the application layer protocol frame may include the encrypted utility meter data or data frame. Optionally, the network gateway may forward the application layer protocol frame over a fixed-wire telecommunications network to a local network demarcation or collection point via wired network communications, such as Ethernet, and/or wireless network communications, such as Wi-Fi, while the utility meter data is maintained in an encrypted data format.

Some embodiments provide a method of detecting a leaking utility. The method comprises a residential network gateway receiving utility usage amount from a utility meter, the residential network gateway forwarding the utility usage amount over a public broadband network to a processing computer located at a data collection point, and the processing computer determining whether the utility usage amount is greater than one or more programmed thresholds, established by the software administrator, above utility usage amounts received from the utility meter during one or more historical periods and/or utility usage amounts received from one or more other utility meters during a current period. The method may further comprise the processing computer generating a service notification in response to determining that the utility usage amount is greater than a standard deviation threshold above the utility usage amounts received from the utility meter during one or more historical periods and/or the utility usage amounts received from the one or more other utility meters during a current period.

In some embodiments, the method of detecting a leaking utility may include any one or more aspects or uses of the utility meter, IoT gateway, network gateway, radio frequency receiver, data framing module, broadband network, application server and/or data storage system disclosed above in reference to the IoT gateway embodiments, the system embodiments and/or the method of handling utility usage data embodiments.

In some embodiments, the method of detecting a leaking utility may further comprise the processing computer determining a total utility usage amount for the utility meter over a period of time and the processing computer sending the total utility usage amount to an application server and/or data storage system.

In some embodiments of the method of detecting a leaking utility, the processing computer may compare the utility usage data to the historical utility usage data received from the utility meter during the same time of year and/or normalized to temperature versus consumption patterns.

In some embodiments of the method of detecting a leaking utility, the utility meter may be installed at a residence having one or more predetermined characteristics, wherein the processing computer compares the utility usage data to utility usage data received from one or more other utility meters that are installed at residences that also have the one or more predetermined characteristics. Optionally, the utility usage amount may be sent to the processing computer using a virtual local area network and/or the processing computer may forward public network communications that are not from the utility meter to a wide area network.

In some embodiments, the method of detecting a leaking utility may further comprise assigning a public IP address to the utility meter, the residential network gateway transmitting a public network communication including the utility usage amount and the public IP address from the network gateway to the processing computer on a dedicated virtual local area network connection, the processing computer directing the public network communication to a designated application server and/or data storage system, and the processing computer transmitting public network communications from the residential network gateway to a wide area network.

Some embodiments enable a utility meter to be read at any desired schedule or frequency that a meter owner desires, such as ranging from continuous readings to a user-defined schedule for reading the amount of utility usage from the utility meter. This capability for reading the meter at any desired schedule or frequency allows each meter owner to conduct real-time data analysis for leak detection, system flow degradation, or potential meter failure that existing systems cannot support. While the utility meter may be set to bubble up data at predetermined intervals, such as every 15, 30 or 60 seconds to 5 minutes, this data is not currently read but once a month for billing purposes due to the effort required to collect the data with a mobile reader. In one example, the utility usage data is read at a desired frequency and sent to the application server. The application server may then automatically analyze the usage data to detect a leak or other problems within the system. Alternatively, an individual user or meter owner may access the application server to initiate diagnostics.

Some embodiments enable the utility meter data, including the amount of utility usage measured by the utility meter, to traverse a fixed-wire telecommunications network from the individual utility meter to a local network demarcation point (e.g., a home network gateway) via wired network communications, such as Ethernet, and/or wireless network communications, such as Wi-Fi, while the meter data may be maintained in an optional encrypted data format.

In some embodiments, the utility meter and/or utility meter reading apparatus may be redesigned to take advantage of fixed-wire telecommunications network elements, thereby reducing an overall cost of the utility meter and the utility meter reading apparatus. For example, a utility meter may be redesigned so that the utility meter is connected to the broadband equipment suite, such as the utility meter using communication protocols that leverage Wi-Fi and/or CAT5/6 Ethernet connections for a hardwired connection from the utility meter to the home network gateway and/or the utility meter receiving electrical power directly from the home electrical system or power-over-ethernet (POE) while potentially leveraging power back-up systems typically deployed with home gateway devices.

In some embodiments, a utility meter that is directly connected with the IoT gateway via an Ethernet cable and/or Ethernet with Power Over Ethernet (POE, which combines data communication and a power source) may no longer require a radio chip and/or a battery. Wi-Fi and/or Ethernet facilitates direct data transmission from the utility meter to the IoT gateway and/or the network gateway or, in the case of a fiber network, to the optical network terminal without the limitations of radio frequency interference or timing constraints of bubble-up transmission settings. An additional beneficial result of a utility meter being connected to a home network gateway/IoT gateway via PoE is that the collection frequency of utility meter data is not constrained by battery life considerations.

In some embodiments, an integrated network gateway/IoT gateway that is a network client of a fixed-wire network and utilized by the utility meter, provides the opportunity for a new integrated broadband home network/IoT gateway design to capture and transport the associated utility meter data. In one example, if the utility meter has a fixed-wire connection to the network, such as a wired connection to the IoT gateway, then the consumer premise equipment (CPE), such as an ONT, of the fixed-wire network may include a battery back-up or other secondary power source that can provide emergency power to the utility meter via PoE. In another example, if the utility meter is a legacy RF-based utility meter, then the home gateway/router may be retrofitted or redesigned to work with or include an RF radio receiver to allow the home gateway/router to read the RF-based utility meter, which may operate with RF-spread spectrum.

Some embodiments described herein, including the method embodiments, may be partially or fully implemented as a computer program product including program instructions that, when executed by a processor, cause the processor to perform, implement or initiate any one or more aspects of the methods described herein. Furthermore, such program instructions may be stored as software or firmware to be executed by a separate processor, such as a central processing unit, or may be implemented in an application specific integrated circuit (ASIC), field-programmable gate array (FPGA) or system on a chip (SoC).

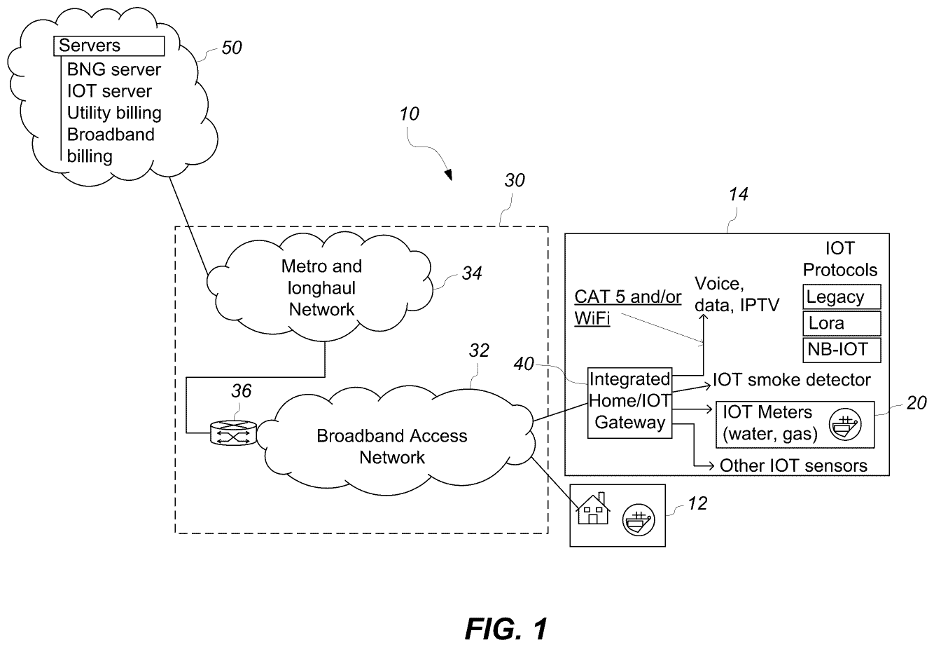

FIG. 1 is a diagram of a system 10 that supports automated reading of one or more utility meter 20 and communication of messages containing utility meter data over a telecommunications network 30. The one or more utility meters 20 may communicate with an IoT gateway, which may be a component of an integrated network gateway/IoT gateway device 40. For example, the one or more utility meters 20 and the integrated network gateway/IoT gateway device 40 may be installed at an individual residence (home) 14, business or other physical location, entity or building. The utility meter 20 at one location may measure an amount of utility usage or consumption and transmit messages or data frames including the amount of utility usage or consumption to the integrated network gateway/IoT gateway device 40 at the same location. Neighboring residences, businesses or other entities may have a similar utility meter and integrated network gateway/IoT gateway. One neighboring residence 12 is illustrated, but an unlimited number of residences or entity locations may be included.

The integrated network gateway/IoT gateway device 40 may also communicate with additional IoT devices at the residence 14. The additional IoT devices may differ from the one or more utility meters 20 by the type of IoT device and/or by the communication protocol used to communicate with the integrated network gateway/IoT gateway device 40. The additional IoT device types are not limited, but are illustrated as including an IoT smoke detector, and the communications protocols are not limited, but may include legacy protocols such as LoRa and NB-IoT. Still further, other IoT devices may communicate with the integrated network gateway/IoT gateway device 40 via a Category 5 (CAT 5) cable and/or a Wi-Fi wireless protocol connection.

The integrated network gateway/IoT gateway device 40 separates the local area network at the residence 14 from the telecommunications network 30, which may be or include a wide area network. The telecommunications network 30 is illustrated as including both a broadband access network 32 and a metro and long haul network 34 separated by a network switch and/or router 36. However, the telecommunications network 30 enables HTTP frames to be sent from the integrated network gateway/IoT gateway device 40 to one or more application servers or data storage systems 50. Non-limiting examples of an application server 50, include a broadband network gateway (BNG) server, IoT server, utility billing server and/or broadband billing server. The server(s) may be implemented in a cloud computing environment and may also be referred to as cloud servers 50.

The end-to-end system may include the integrated broadband network gateway/IoT gateway 40 at a residence 14, broadband access network 32 and metro network 34, and cloud servers 50. For example, the broadband access network 32 may be used to transmit the utility meter data to a head-end of a service provider. From there, the utility meter data may need to be sent to other networks, which may or may not be built/controlled by the Internet Service Provider (ISP), so that the data can be sent to a datacenter/physical private servers/cloud/etc. 50 depending on where a utility provider may want to receive the utility meter data. The cloud servers 50 may include broadband network gateway (BNG) servers for broadband triple-play services; IoT servers that support various IoT protocols, such as Lora, NB-IoT, legacy SCM/SCM+, etc., for utility meter data; and/or customer billing servers for broadband and/or utilities. The broadband access network and metro network are public networks and the proposed IoT system may use these networks without modifications.

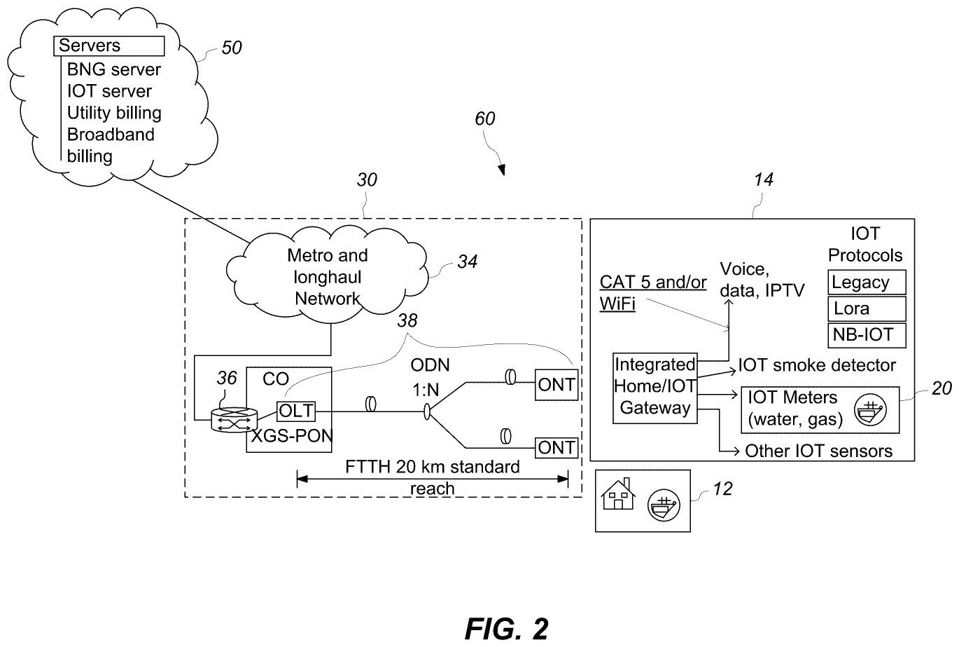

FIG. 2 is a diagram of a system 60 that is similar to the system 10 of FIG. 1 except that the broadband access network 32 within the telecommunications network 30 has been specifically illustrated as an optical fiber network 38. For example, the optical fiber network 38 may be a passive optical network (PON) or fiber-to-the-home (FTTH) network. Accordingly, the integrated broadband network gateway/IoT gateway 40 may communicate over the PON FTTH network to a central office (CO), aka head-end, where the optical distribution network ends and transfers over to the metro/long-haul network 34.

An Optical Distribution Network (ODN) includes conduit, fiber, and splitters between the Optical Line Terminal (OLT) in the central office (CO) and the Optical Network Terminal (ONT). The optical distribution network split ratio (1:N) indicates that a single optical fiber can be split 1:8, 1:16: or 1:32 or more to support multiple homes on a single ODN. The OLT (Optical Line Terminal) communicates with 8, 16, 32, or more ONTs with Point-to-multiple Point protocols. Nonlimiting examples of the passive optical network (PON) includes XG-PON and G-PON.

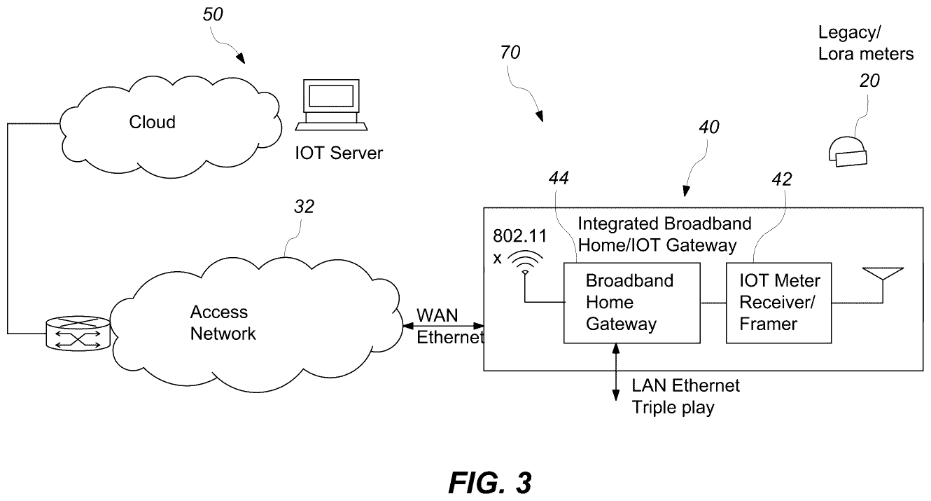

FIG. 3 is a diagram of a system 70 including an integrated home network gateway/IoT gateway 40. The integrated home network gateway/IoT gateway 40 includes an IoT meter receiver and data framer 42 for utility meter data collection and a broadband home network gateway 44. In the illustrated example, the home network gateway 44 may provide triple-play services, including broadband Internet access, television and telephone/voice. The Internet access may be distributed to other computing devices over a local area network (LAN) including wired Ethernet and/or wireless Wi-Fi connections. The wide area network (WAN) interface of the integrated broadband home/IoT gateway communicates with IoT servers in the cloud via fixed access networks.

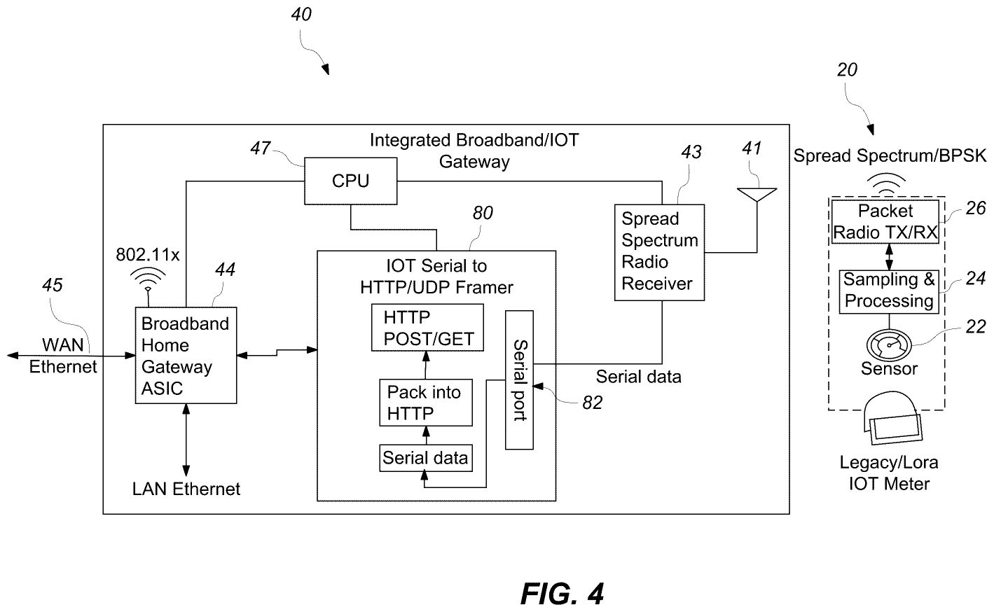

FIG. 4 is a diagram of the components of an integrated home network gateway/IoT gateway 40 and the components of a legacy utility meter 20, such as a LoRa utility meter or Itron automated meter reader (AMR). The utility meter 20 includes, without limitation, a physical sensor 22, a sampling and processing unit 24, and a packet radio transceiver 26. For example, the radio transceiver may transmit a spread spectrum signal, such as a binary phase shift keying (BPSK) signal.

The physical sensors 22 may converge the machinery rotation movements in the utility meters into a raw signal pulse. The sampling and data processing unit 24 calibrates the raw signal pulse from the sensor into utility usage or consumption data and further packs the data into “meter” frames. For example, the meter frames may consist of preambles, head, meter ID, customer ID, utility usage/consumption data and cyclic redundancy check (CRC). For legacy meters and LoRa meters, which are not Internet Protocol (IP) addressable, the meter data frames are directly transmitted by the transceiver 26. Legacy meters and LoRa meters are not IP addressable because the chipset included in the encoder receiver transmitters (ERTs) (for RF/Itron based meters) and LoRa meters are a closed network which does not require the use of IP addresses. The receiver transmitter unit 26 may transmit the frames from the data processing unit 24 over spread spectrum radio links.

The IoT meter receiver/framer 42 of FIG. 3 is now shown as two separate components, namely an IoT Serial to HTTP/UDP Framer 80 and a spread spectrum radio receiver 43 coupled to an antenna 41. The spread spectrum radio receiver 43 on the Integrated Broadband/IoT Gateway receives the radio signal from the IoT meter receiver/transmitter 26 and demodulates the RF signal into serial data that consists of the utility meter data frame. In the case of an Itron meter, the serial data received by the radio receiver consists of Itron's SCM/SCM+ (Standard Consumption Message) meter data frames. The radio receiver 43 may be designed as a configurable sampling frequency controller to adapt to the needs of different applications. One example of an application that preferably has a higher sampling rate is gas leak detection.

The IoT processing unit (“IoT Serial to HTTP/UDP Framer”) 80 on the Integrated Broadband Home/IoT Gateway 40 receives the serial data from the spread spectrum radio receiver 43, where the serial data may that consists of utility meter data frames. The Framer 80 may then map the meter data frame (serial data) into IP packets. Accordingly, the Integrated broadband Home/IoT gateway 40 receives the meter data from the utility meters 20, including legacy meters and Lora meters (which are not IP addressable) and places the meter data in a frame that is IP addressable. In one option, the Framer 80 further maps the IP frame that consists of the meter data into HTTP frames. The HTTP frames are then sent to the broadband home network gateway 44 for combining with other home data traffic so that any or all of home data traffic may be forwarded to the Wide Area Network (WAN) interface 45 for transmission onto the access network. For example, the WAN interface 45 of the Integrated Broadband/IoT Gateway 40 may connect to the Passive Optical Network (PON) (see FIG. 2) for communicating data to the Internet.

The IoT Serial to HTTP/UDP Framer 80 may be an ASIC that is programmed or configured to receive the utility meter data from the receiver 43 at the serial port 82 and perform the operations of placing the utility meter data into an IP addressable frame and into an HTTP frame before forwarding the HTTP frame to the broadband home gateway 44. A central processing unit (CPU) 47 is provided to coordinate the operations of the components 44, 80, 43, such as controlling clock and synchronization to support operation and communication between the components.

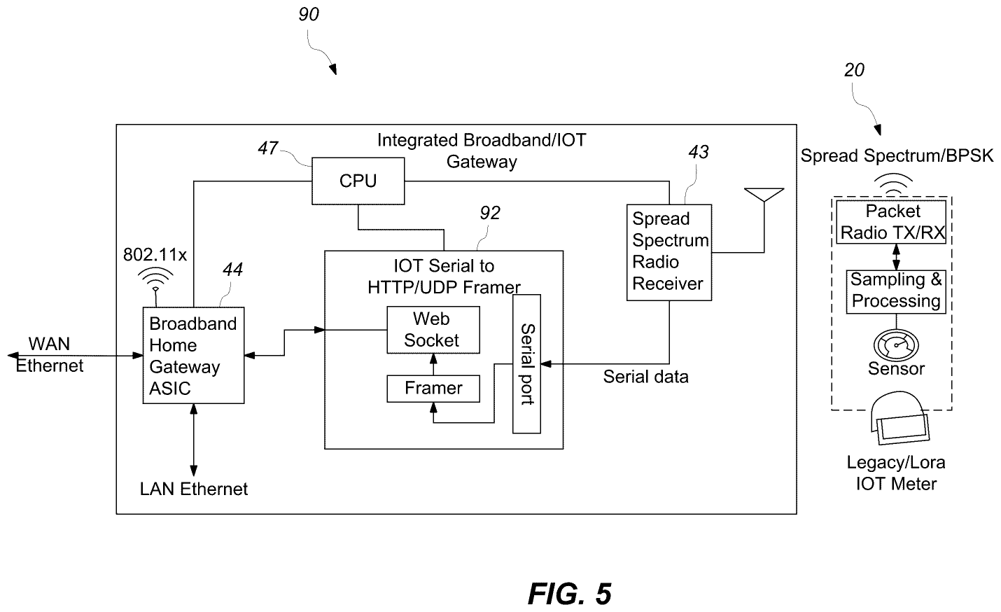

FIG. 5 is a diagram of an integrated network gateway/IoT gateway 90 that forms a WebSocket connection for sending utility usage data. The integrated network gateway/IoT gateway 90 is substantially similar to the gateway 40 that in FIG. 4, except that the Framer 92 forms a WebSocket protocol connection and communicates over the WebSocket. WebSocket is a computer communications protocol, providing full-duplex communication channels over a single TCP connection. Accordingly, the framer 92 maps the IP frame that consists of the meter data into a web socket protocol message. The web socket is a permanent packet connection from broadband home/IoT gateway 90 to the cloud servers 50 (see FIGS. 1-3) in the cloud.

In some embodiments, the Integrated Broadband Home/IoT gateway 40, 90 may be implemented on any general-purpose network processing and control component, such as a Central Processing Unit (CPU) with sufficient processing power, memory resources, and capability to handle instruction execution, logical operations, hardware devices control, clock and synchronization, memory and buffer management, scheduling, and I/O management.

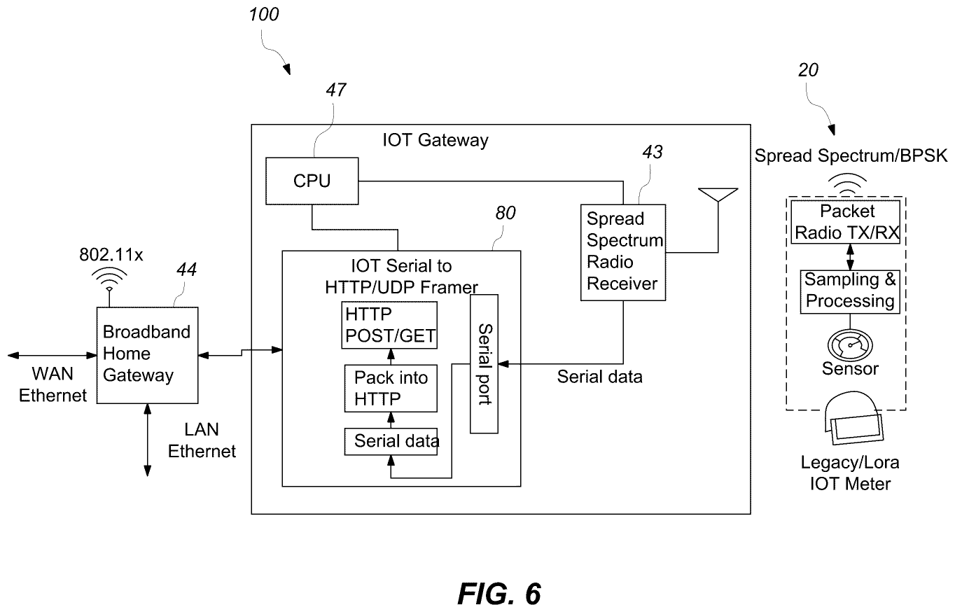

FIG. 6 is a diagram of an IoT gateway 100 connected to an external home network gateway 44 for sending an HTTP frame to a wide area network. The IoT gateway 100 operates in conjunction with the home network gateway 44 in the same manner as the integrated home network gateway/IoT gateway 40 in reference to FIG. 4, except that the home network gateway 44 is a separate component from (i.e., not integrated with) the IoT gateway. As a result, the home network gateway 44 will have its own central processing unit (CPU) (not shown).

Accordingly, the IoT gateway 100 is a standalone unit that may be connected to a broadband home gateway device 44 via Ethernet or Wi-Fi connections. The functions of the IoT gateway 100 may be the same as the IoT gateway portion of the integrated broadband/IoT home gateway 40 described in reference to FIG. 4.

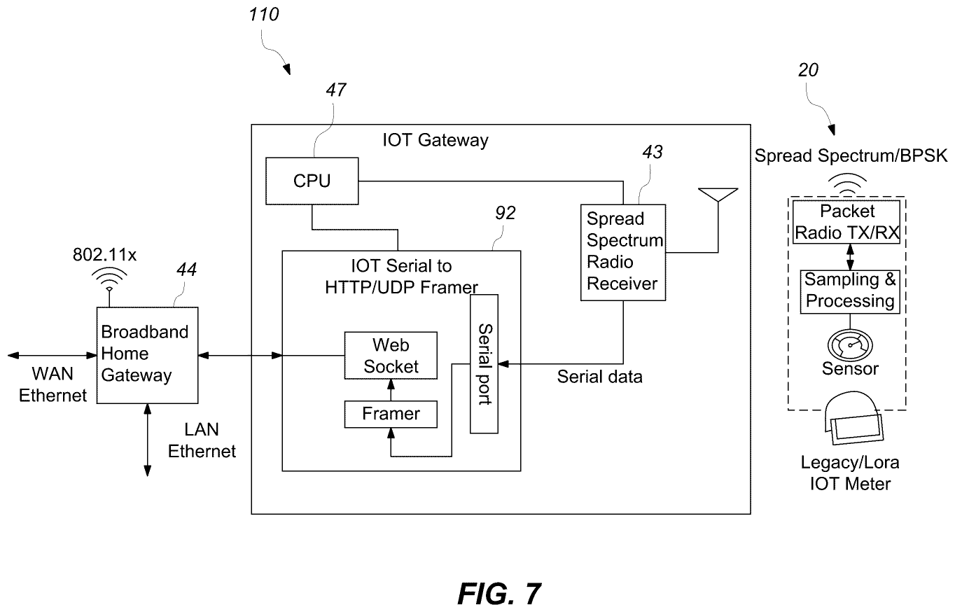

FIG. 7 is a diagram of an IoT gateway 110 connected to an external home network gateway 44 using a WebSocket connection. The IoT gateway 110 operates in conjunction with the home network gateway 44 in the same manner as the integrated network gateway/IoT gateway 90 in reference to FIG. 5, except that the home network gateway 44 is a separate component from (i.e., not integrated with) the IoT gateway. As a result, the network gateway 44 will have its own central processing unit (CPU) (not shown).

Accordingly, the IoT gateway 110 is a standalone unit that may be connected to a broadband home gateway device 44 via Ethernet or Wi-Fi connections. The functions of the IoT gateway 110 may be the same as the IoT gateway portion of the integrated broadband/IoT home gateway 90 described in reference to FIG. 5.

In some embodiments, the Integrated IoT gateway 100, 110 may be implemented on any general-purpose network processing and control component, such as a Central Processing Unit (CPU) with sufficient processing power, memory resources, and capability to handle instruction execution, logical operations, hardware devices control, clock and synchronization, memory and buffer management, scheduling, and I/O management.

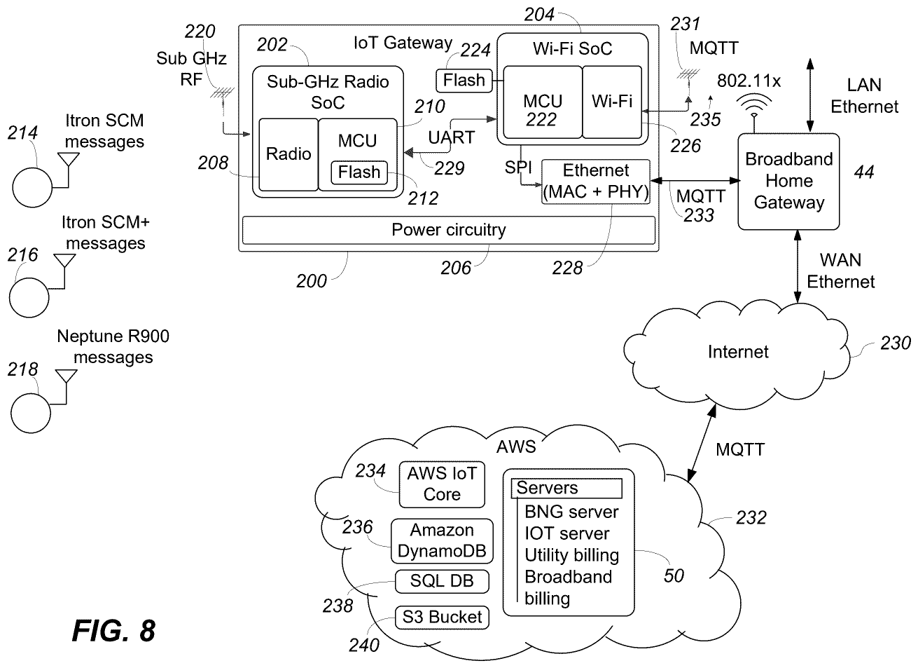

Referring now to FIG. 8, an IoT gateway 200 is illustrated. The components of the IoT gateway 200 include a sub-GHz radio SoC 202, a Wi-Fi SoC 204 and power circuitry 206. The sub-GHz radio SoC 202 includes a radio module 208 and a microcontroller (MCU) 210, which includes embedded flash memory 212 for storing executable programs, such as an operating system and programs to receive utility meter data and provide the utility meter data to the Wi-Fi SoC 204. An antenna 220 is connected to the radio module 208. Antenna 220 and the radio module 208 are used to read data from various metering devices such as a device having using iTron SCM messages 214, a device using iTron SCM+messages 216 and a device 218 providing Neptune R900 messages.

The Wi-Fi SoC 204 includes a Wi-Fi module 226 and MCU 222. A flash module 224 is connected to the MCU 222 to provide program memory storage capabilities, with exemplary programs including an operating system and network stack and programs to receive data from the sub-GHz radio SoC 202, place the utility meter data in application layer protocol frames and provide the application layer protocol frames to the Wi-Fi module 226 or other element to transmit the application layer protocol frames. An Ethernet module 228 is connected to the Wi-Fi SoC 204 to provide Ethernet capabilities for the IoT gateway 200. An antenna 231 is connected to the Wi-Fi module 226. In the embodiment illustrated in FIG. 8, the sub-GHz radio SoC 202 and the Wi-Fi SoC 204 are connected by a serial or UART link 229. In other embodiments, other connections between the sub-GHz radio SoC 202 and the Wi-Fi SoC 204 can be used, such as a parallel link, high-speed serial link and so on. The utility meter data is transmitted over the UART link in a predetermined format, which predetermined format may be dependent on the utility meter. In many examples, driver circuitry (not shown) is included to connect the sub-GHz radio SoC 202 to the antenna 220 and the Wi-Fi SoC 204 to the antenna 231. In the example, the Wi-Fi SoC 204 is performing the functions of the data framing module discussed above.

The IoT gateway 200 is connected to a broadband home gateway 44, either by a wired Ethernet connection 233 or via Wi-Fi 235. The broadband home gateway 44 is connected to the Internet 230 and to a compute cloud 232, such as Amazon Web Services (AWS). The compute cloud 232 includes an AWS IoT core 234, an Amazon DynamoDB database 236, a SQL database 238 and an S3 storage bucket 240. The cloud servers 50 also execute in the compute cloud 232.

In the illustrated embodiment, the communications from the IoT gateway 200 are MQTT frames being provided to the broadband home gateway 44. The broadband home gateway 44 forwards these MQTT frames to the AWS IoT core 234. The AWS IoT core 234 is programmed to deposit the data contained in the MQTT frames into the Amazon DynamoDB database 236. The cloud servers 50 then utilize the data stored in the Amazon DynamoDB database 236 to perform the various utility functions. The AWS IoT Core 234 acts as the communication front end or intermediary for the cloud servers 50. The cloud servers 50 provide commands and instructions to the IoT gateway by providing the commands and instructions to the AWS IoT core 234, which forwards the commands and instructions as MQTT frames to the IoT gateway.

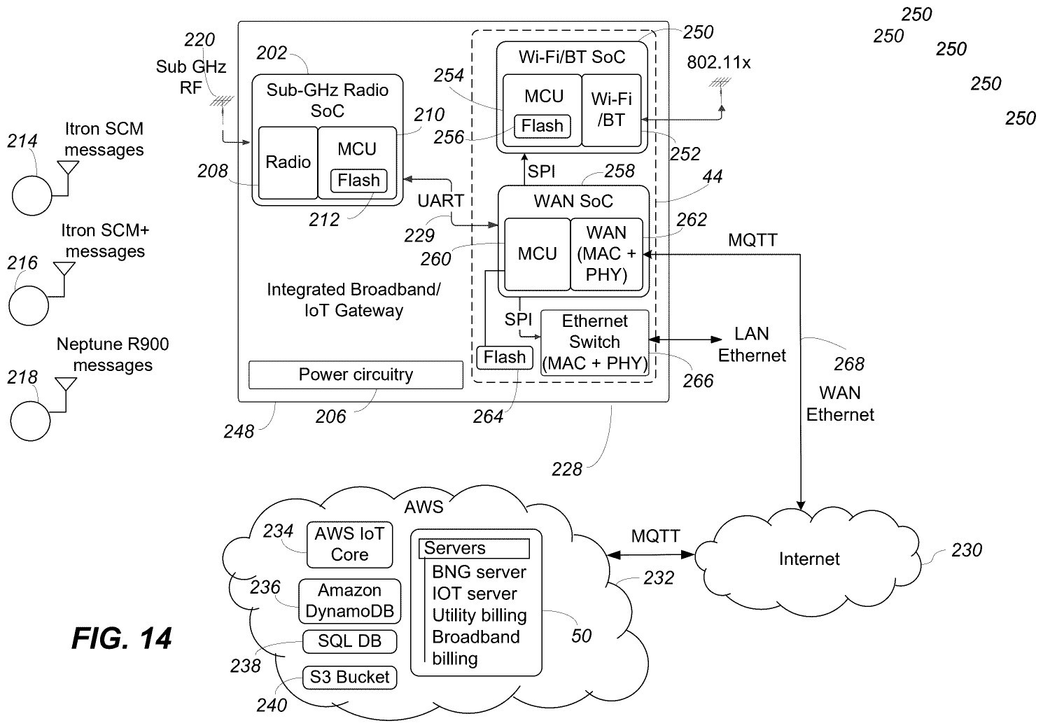

FIG. 8 is a more detailed diagram of the IoT gateway 200 but it is understood that numerous other configurations of components can be used to provide the sub-GHz radio and Wi-Fi or Ethernet communications and convert data from the meter format to an application layer protocol format. For example, as illustrated in FIG. 14, the home gateway 44 can be incorporated into the IoT gateway to form an Integrated Broadband/IoT gateway 248, similar to the Integrated Broadband/IoT gateway 40 or 90.

In FIG. 14, the Wi-Fi SoC 204 is changed to a Wi-Fi/Bluetooth (BT) SoC 250, which includes an MCU 254, with embedded flash memory 256 containing wi-Fi and Bluetooth programs, and a Wi-Fi/BT module 252. This can be a conventional Wi-Fi/Bluetooth SoC. A WAN SoC 258 includes an MCU 260 and a WAN Ethernet module 262 with a MAC and a PHY. A flash memory 264 is connected to the MCU 260 to store conventional broadband gateway programs but also the IoT functions previously performed by the Wi-Fi SoC 204. This includes receiving utility data packets from the sub-GHz radio SoC 202 and loading the utility data into application layer protocol packets. The WAN module 262 Ethernet port is connected to the Internet 230 to provide wide area networking. An Ethernet switch 266 is connected to the WAN SoC 258 to provide local Ethernet network capabilities.

In another embodiment of integrating the sub-GHz radio SoC 202 with the home broadband gateway 44, the functions of the sub-GHz Radio SoC 202 are expanded to include the IoT functions of the Wi-Fi SoC 204, such as placing the utility data in an application layer protocol frame, and providing the application layer protocol frame to the broadband home gateway 44 over any of various connections. The home broadband gateway 44 can then be generally of conventional configuration, except for exchanging the application layer protocol frames with the sub-GHZ radio SoC.

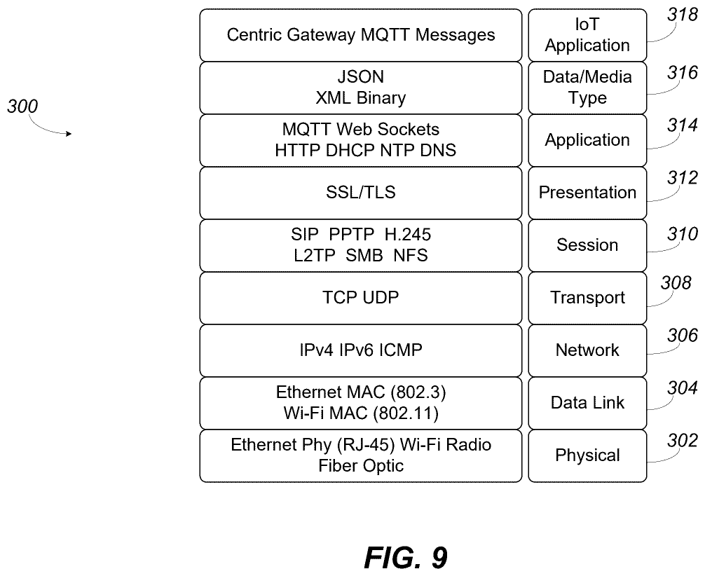

Referring now to FIG. 9, an OSI layer illustration 300 is provided. Layer 1 is a physical layer 302. Layer 2 is a data link layer 304. Layer 3 is a network layer 306. Layer 4 is a transport layer 308. Layer 5 is a session layer 310. Layer 6 is a presentation layer 312. Layer 7 is an application layer 314. Above the application layer 314 are data/media types 316 and applications 318 running on a particular device, such as the IoT application. Examples of the physical layer 302 include Wi-Fi, fiber-optic cables and physical Ethernet cables. Examples of the data link layer 304 are Ethernet and Wi-Fi packets at the protocol level. Examples of the network layer 306 are the IP protocols such as IPv4 and IPV6. Examples of the transport layer 308 are protocols such as TCP and UDP. Examples of the session layer 310 are SIP, H.245, PPTP, L2TP, SMB and NFS. Examples of the presentation layer 312 are SSL and TLS. Examples of the application layer 314 are HTTP, Web sockets, MQTT, DHCP and others. Examples of the media types 316 include JSON, XML and binary. Exemplary IoT application 318 is a gateway for the MQTT packets provided by the IoT gateway 200 and any of the elements in the computer cloud 232, such as cloud servers 50.

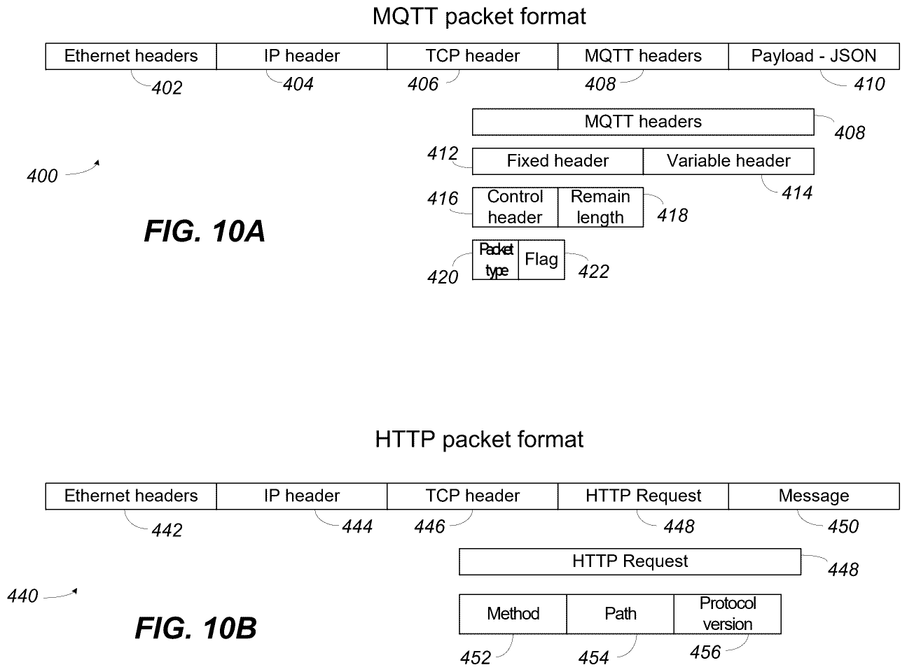

FIG. 10A illustrates an exemplary MQTT packet format. The MQTT packet 400 includes Ethernet headers 402, an IP header 404, a TCP header 406, various MQTT headers 408 and the payload data, such as JSON 410. The MQTT headers 408 break down into a fixed header 412 and a variable header 414. The fixed header 412 includes a control header field 416 and a remaining length field 418. The control header 416 includes fields for packet type 420 and various flag bits 422.

FIG. 10B illustrates an HTTP packet format. The HTTP packet 440 includes Ethernet headers 442, an IP header 444, a TCP header 446, an HTTP request 448 and the message 450. Message 450 can be JSON similar to the payload JSON 410 in the MQTT packet 400. The HTTP request 448 includes a method field 452, the path 454 to the target of the HTTP request 448 and the HTTP protocol version 456.

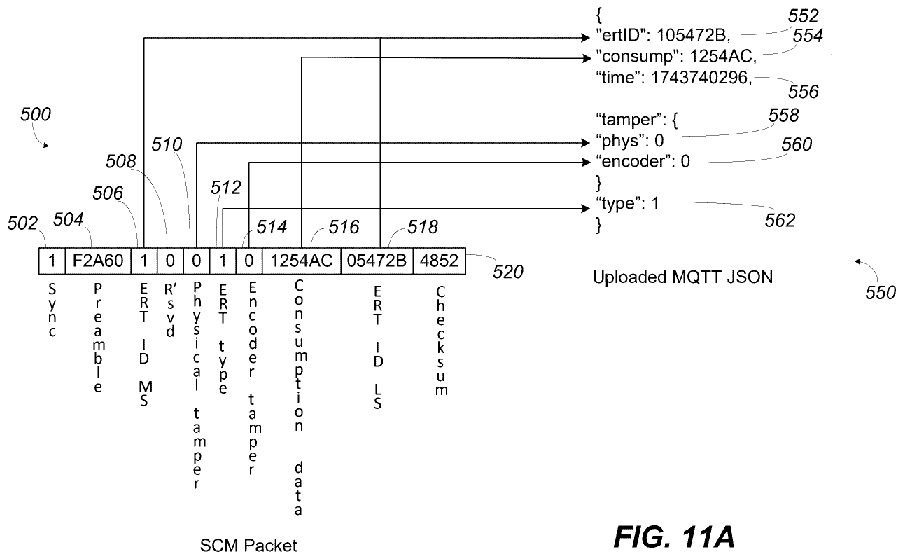

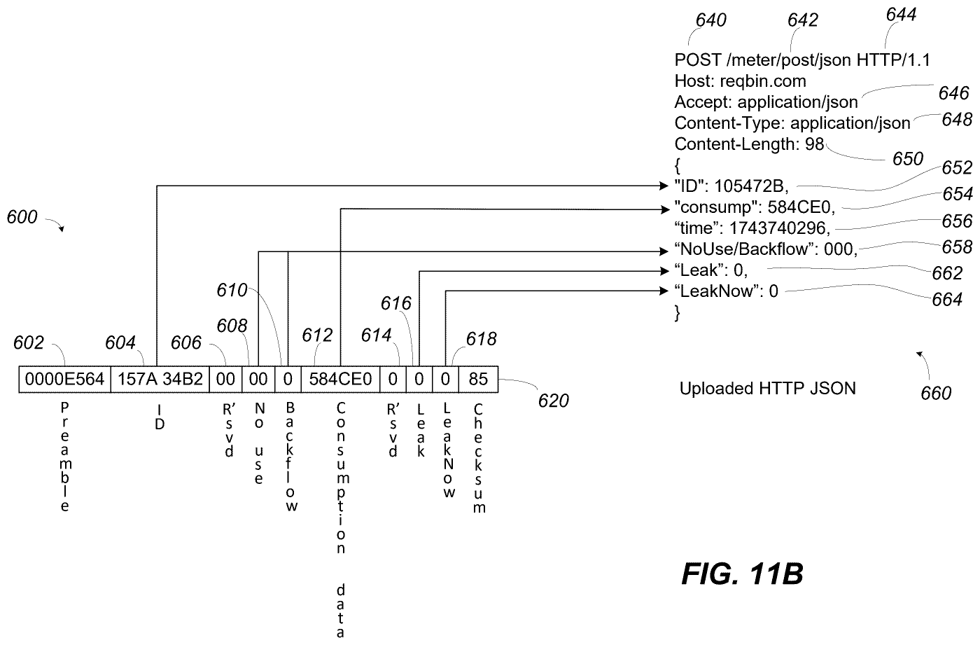

FIG. 11A provides a mapping between an SCM packet and an exemplary JSON payload for an MQTT packet. All illustrated values are in hexadecimal format. The SCM packet 500 includes a sync bit 502, a preamble 504, the two most significant bits of the encoder receiver transmitter (ERT) device ID 506, a reserved bit 508, two physical tamper bits 510, four ERT type bits 512, two encoder tamper bits 514, 24 bits of consumption data value 516, the lower 24 bits of the ERT ID 518 and a 16-bit checksum 520. Programs operating on the MCU 222 of the Wi-Fi SoC 204 receive the SCM packet 500 from the sub-GHz radio SoC 202 and parse the SCM packet 500. In the illustrated embodiment, the MQTT data is a JSON payload 550. The first field of the JSON data 552 is the ERT ID, which is formed from the ERT ID most significant bits 506 and the ERT ID least significant bits 518. The consumption value 554 is next, followed by a timestamp 556, typically a Linux timestamp. The timestamp 556 is followed by the physical tamper bits 558 and the encoder tamper bits 560. The JSON data concludes with the ERT type value 562. As the JSON is textual, the data is easy to use by the cloud servers 50.

FIG. 11B illustrates an exemplary mapping between a Neptune R900 packet 600 and HTTP JSON 660. The R900 packet 600 includes a 64 bit preamble 602, a 32 bit ID field 604, eight reserved bits 606, six bits of day bins of no use 608, two backflow bits 610, 24 bits of consumption data 612, two reserved bits 614, four bits of day bins of leaks 616, two bits for hi and lo leak in the past 24 hours, the leak now bits 618 and checksum 620. The illustrated HTTP JSON message 660 includes the HTTP request of the post method 640, with a path 642 and protocol version 644. The message includes an application JSON extension 646, a content type indication of JSON 648 and a content length value 650. This is followed by the actual JSON statements. In the illustrated embodiment, the ID value from the 900 packet is provided as the ID 652, followed by the consumption value 654, a Linux timestamp 656, the no use and backflow bits 658, the leak bits 662 and the leak now bits 664.

Therefore, the operation of the IoT gateway 200 translates the meter message packet such as SCM, SCM+ or R900 into application layer formats such as in MQTT and HTTP, preferably using JSON values. The IoT gateway 200 develops the full MQTT or HTTP packet as illustrated in FIGS. 10A and 10B. This MQTT or HTTP packet is provided to the broadband home gateway 44, which provides the application layer protocol packet to the compute cloud 232 for use by the cloud servers 50.

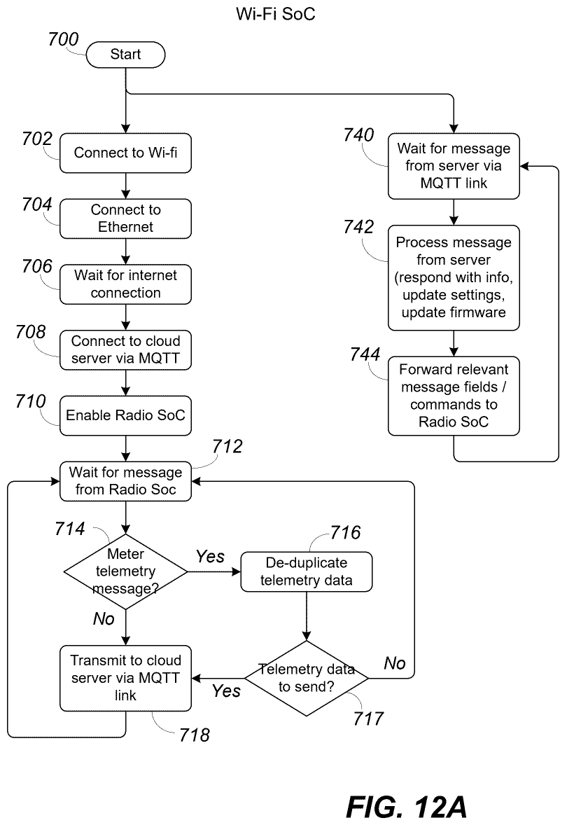

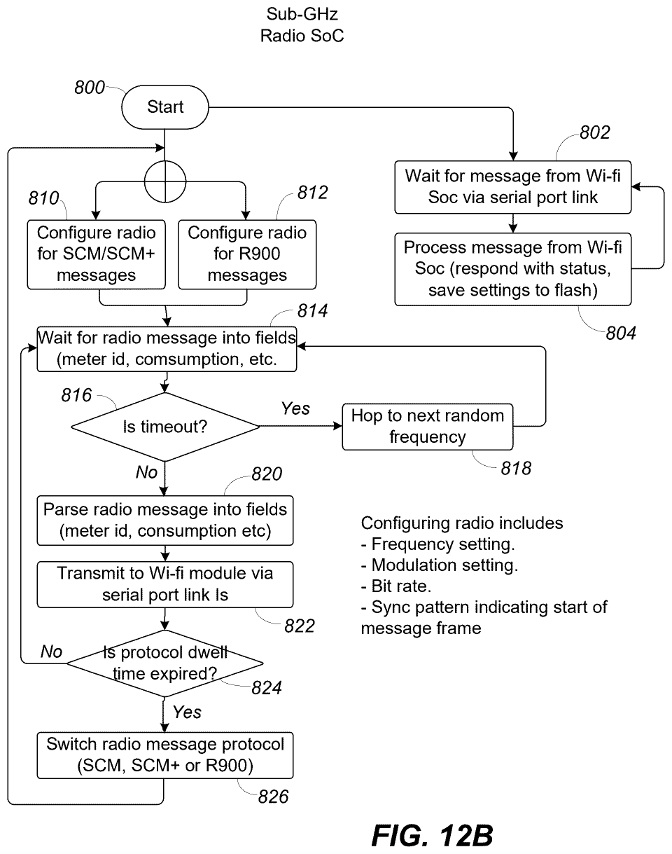

FIG. 12A is a flowchart of the operation of the Wi-Fi SoC 204. In step 700, the operation commences in a first thread where a Wi-Fi connection is made by the Wi-Fi module 226 to the broadband home gateway 44 via the Wi-Fi link, if Wi-Fi is to be used. In step 704, connection is made using the Ethernet module 228 to the broadband home gateway 44 with an Ethernet link, if an Ethernet link is to be used. In step 706, the Wi-Fi SoC 204 waits until an Internet connection is provided by the broadband home gateway 44. In step 708, the Wi-Fi SoC 204 connects to the compute cloud 232, the AWS IoT core 234 and the cloud servers 50, via MQTT setup packets in the illustration. In step 710, the sub-GHz radio SoC 202 is enabled. In step 712, the Wi-Fi SoC 204 waits to receive a message from the sub-GHz radio SoC 202. In step 714, a determination is made whether the received message is a telemetry message containing utility meter usage information or a system message. If it is usage information, in step 716 the usage or telemetry data is de-duplicated. In many cases, the various meters present or provide the data in 15 seconds 30 seconds, one minute, or five minute intervals. In many instances there is no change in the consumption value of the meter. Therefore, because there is no consumption data change, there is no need to transmit this usage packet to the cloud servers 50 because there has been no data change. This de-duplication step 716 dramatically reduces the amount of traffic provided by the IoT gateway 200. In step 714, if the message is not a telemetry message containing usage data, the message is directed to the cloud servers 50 as control messages in step 718. After the telemetry de-duplication in step 716, in step 717 it is determined if there is telemetry data to send to the cloud servers 50 via the AWS IoT core 234. If so, that data is transmitted in step 718. If there is no telemetry data to send, operation returns to step 712. After step 718, operation returns to step 712 to await the next message from the sub-GHz radio SoC 202.

A second thread for the Wi-Fi SoC 204 is a message thread waiting for messages from the cloud servers 50. Therefore, in step 740 the operation is waiting for a message from the cloud servers 50 via the MQTT link. In step 742, the message is processed, such as providing requested information, updating settings in the IoT gateway 200 or the meter and updating firmware contained in the flash 224 or the flash 212. In step 744, any messages or commands are provided to the sub-GHz radio SoC 202. Operation then returns to step 742 to await the next message from the cloud servers 50.

FIG. 12B illustrates the operation of the sub-GHz radio SoC 202. Operation commences at step 800 with a first thread waiting for messages from the Wi-Fi SoC 204 in step 802. Any messages received are processed in step 804, such as returning status, setting values in flash memory and so on. Operation returns to step 802 to wait for further messages.

In a data reading thread, the radio module 208 is configured for SCM or SCM+ messaging in step 810 or R900 messaging in step 812. To configure the radio includes various steps such as frequency setting, modulation setting, bit rate and determining the sync pattern to indicate the beginning of a utility meter message frame. After the radio is configured in step 810 or 812, in step 814 the sub-GHz radio SoC 202 waits in step 814 for a message to be received over the meter RF link. If a message is not received in 45 seconds in step 816, then operation proceeds to step 818, where the radio is hopped to the next random frequency in the meter spread spectrum operation. Operation then returns to step 814 to await a radio message. If a message is received and is not timed out after step 816, in step 820 the message is parsed into the various fields such as those illustrated in FIGS. 11A and 11B. The utility meter packet values are provided in step 822 to the Wi-Fi SoC 204 so that the values can be converted into the MQTT or HTTP application layer protocol format and provided to the cloud servers 50 via the AWS IoT core 234. In step 824, it is determined if a protocol dwell time has expired. It is preferable to monitor each of the protocols for a selected period of time to capture values from various meters within the collection range of the sub-GHz radio SoC 202. For example, there may be a gas meter and a water meter at the location of the IoT gateway 200 with further water meters and gas meters at neighboring locations. The single IoT gateway 200 may be able to read meter readings from these locations. But the gas and water meters may use different protocols, so the protocol must be changed. The dwell time allows sufficient time to read all meters of a given protocol. The dwell times are programmable values and depends upon the particular protocols and how frequently the meters communicate or bubble data up. If a protocol dwell time is expired, then in step 826 the protocol is switched, such as from SCM to SCM+ to R900. Operation returns to steps 810 and 812 to configure the radios appropriately. If the dwell time has not expired, operation returns to step 814 to wait for the next meter RF message.

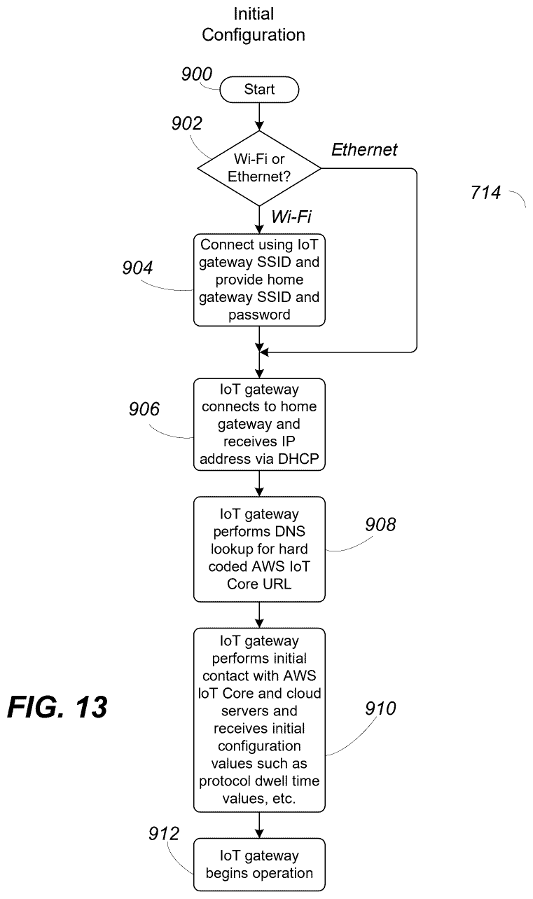

FIG. 13 illustrates initialization of an IoT gateway. Operation commences at step 900. In step 902, it is determined if the IoT gateway is connecting to the home gateway 44 by Wi-Fi or Ethernet. If by Wi-Fi, in step 904 a device such as a mobile phone or laptop connects to the IoT gateway using an SSID broadcast by the IoT gateway. The home gateway 44 SSID and password are provided to the IoT gateway. After step 904 or if connecting using Ethernet, in step 906 the IoT gateway connects to the home gateway 44 and receives an IP address via DHCP. In step 908, the IoT gateway performs a DNS lookup for the AWS IoT Core URL, which is preferably hard coded into the IoT gateway. If the AWS IoT Core URL is not hard coded or has changed, an AWS IoT Core URL can be provided with the home gateway 44 SSID and password in step 904 or provided in a step following step 906 using the IoT gateway IP address. Then step 908 is performed on the provided AWS IoT Core URL. In step 910, the IoT gateway makes initial contact with the AWS IoT Core 234 and the cloud servers 50. The IoT gateway is provided initial configuration values from the cloud servers 50, such as protocol dwell times based on the intended installation location and other initialization values. The IoT gateway begins operating in step 912.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition, or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An Internet of Things (IoT) gateway, comprising:
a sub-GHz radio system for receiving radio frequency utility meter data packets from at least one utility meter; and
a utility data transmitting system coupled to the sub-GHz radio system and for coupling to a residential home gateway, which in turn is connected to a wide area network, which in turn is coupled to a utility server,
wherein the sub-GHz radio system is configured to receive radio frequency utility meter packets in a format transmitted by the utility meter, the format including at least identification and consumption data values, and to provide at least the identification and consumption data values to the utility data transmitting system in a predetermined format, and
wherein the utility data transmitting system is configured to package received identification and consumption data values as a payload of an application layer protocol frame and prepare the remainder of the application layer protocol frame addressed to the utility server for provision to the residential home gateway to allow the residential home gateway to direct the application layer protocol frame to the utility server.

2. The IoT gateway of claim 1, further comprising:
an antenna connected to the sub-GHz radio system to detect the radio frequency utility meter data packets.

3. The IoT gateway of claim 1, wherein the sub-GHz radio system is configured to operate with a plurality of utility meter radio frequencies and a plurality of radio frequency utility meter packet formats.

4. The IoT gateway of claim 3, wherein a least one of the plurality of utility meter radio frequencies is a spread spectrum radio frequency.

5. The IoT gateway of claim 4, wherein the at least one of the plurality of utility meter radio frequencies that is spread spectrum conforms to the LoRa standard.

6. The IoT gateway of claim 1, wherein the utility data transmitting system includes a Wi-Fi module, and wherein the utility data transmitting system is configured to couple to the residential home gateway using Wi-Fi.

7. The IoT gateway of claim 1, wherein the utility data transmitting system includes an Ethernet module, and wherein the utility data transmitting system is configured to couple to the residential home gateway using Ethernet.

8. The IoT gateway of claim 1, wherein the sub-GHz radio system and the utility data transmitting system are configured to operate with a plurality of utility meters in a local neighborhood.

9. An integrated broadband and Internet of Things (IoT) gateway, comprising:
a sub-GHz radio system for receiving radio frequency utility meter data packets from at least one utility meter; and
a broadband gateway coupled to the sub-GHz radio system and for connecting to a wide area network (WAN), which in turn is coupled to a utility server, the broadband gateway including:
a Wi-Fi module for providing a Wi-Fi local network;
a WAN system coupled to the Wi-Fi module, the WAN system including:
a WAN Ethernet port for connecting to the WAN; and
an interface connected to the sub-GHz radio system; and
an Ethernet switch coupled to the WAN system for providing an Ethernet local area network,
wherein the sub-GHz radio system is configured to receive radio frequency utility meter packets in a format transmitted by the utility meter, the format including at least identification and consumption data values, and to provide at least the identification and consumption data values to the broadband gateway in a predetermined format, and
wherein the broadband gateway is configured to package received identification and consumption data values as a payload of an application layer protocol frame and prepare the remainder of the application layer protocol frame addressed to the utility server for provision to the WAN to direct the application layer protocol frame to the utility server.

10. The IoT gateway of claim 9, further comprising:
an antenna connected to the sub-GHz radio system to detect the radio frequency utility meter data packets.

11. The IoT gateway of claim 9, wherein the sub-GHz radio system is configured to operate with a plurality of utility meter radio frequencies and a plurality of radio frequency utility meter packet formats.

12. The IoT gateway of claim 11, wherein a least one of the plurality of utility meter radio frequencies is a spread spectrum radio frequency.

13. The IoT gateway of claim 12, wherein the at least one of the plurality of utility meter radio frequencies that is spread spectrum conforms to the LoRa standard.

14. The IoT gateway of claim 9, wherein the sub-GHz radio system and the broadband gateway are configured to operate with a plurality of utility meters in a local neighborhood.

15. A system comprising:
a utility meter including a sensor for measuring utility usage and a radio frequency transmitter for transmitting utility usage data as utility meter data packets in a selected format; and
an Internet of Things (IoT) gateway, including:
a sub-GHz radio system for receiving radio frequency utility meter data packets from the utility meter; and
a utility data transmitting system coupled to the sub-GHz radio system and for coupling to a residential home gateway, which in turn is connected to a wide area network, which in turn is coupled to a utility server,
wherein the sub-GHz radio system is configured to receive radio frequency utility meter packets in the selected format transmitted by the utility meter, the selected format including at least identification and consumption data values, and to provide at least the identification and consumption data values to the utility data transmitting system in a predetermined format, and
wherein the utility data transmitting system is configured to package received identification and consumption data values as a payload of an application layer protocol frame and prepare the remainder of the application layer protocol frame addressed to the utility server for provision to the residential home gateway to allow the residential home gateway to direct the application layer protocol frame to the utility server.

16. The system of claim 15, further comprising:
an antenna connected to the sub-GHz radio system to detect the radio frequency utility meter data packets.

17. The system of claim 15, wherein the sub-GHz radio system is configured to operate with a plurality of utility meter radio frequencies and a plurality of radio frequency utility meter packet formats.

18. The system of claim 15, wherein the utility data transmitting system includes a Wi-Fi module, and
wherein the utility data transmitting system is configured to couple to the residential home gateway using Wi-Fi.

19. The system of claim 15, wherein the utility data transmitting system includes an Ethernet module, and
wherein the utility data transmitting system is configured to couple to the residential home gateway using Ethernet.

20. The system of claim 15, further comprising:
a second utility meter for installation in a location near the utility meter and including a sensor for measuring utility usage and a radio frequency transmitter for transmitting utility usage data as utility meter data packets in a second selected format,
wherein the sub-GHz radio system and the utility data transmitting system are configured to operate with utility meter and the second utility meter.
